(19) United States
(12) Patent Application Publication
(10) Pub. No.: US 2012/0019392 A1
(43) Pub. Date: Jan. 26, 2012

(54) USB Charger

(75) Inventors: Yasuhiro Yamamoto, Los Angeles, CA (US); Arthur L. Serrano, West Hills, CA (US)

(73) Assignee: EVER WIN INTERNATIONAL CORPORATION, City of Industry, CA (US)

(21) Appl. No.: 12/840,883

(22) Filed: Jul. 21, 2010

(51) Int. Cl. G08B 21/00

(52) U.S. Cl. 340/664

(57) ABSTRACT

A USB charger comprises a power input, a microprocessor, a resistor network, and a USB port for charging electronic devices through the USB port. The USB charger defaults to provide 2000 mA when power is applied through the power input. When a device is detected at the USB port, it measures device current drain to determine if it is charging. If the device is charging, then it remains in the 2000 mA charging mode. If no current drain is detected, the power supply switches to 1000 mA. If the electronic device recognizes the proper charging network it will begin charging. When the microprocessor detects current drain, it leaves the charging network as is. If still no current drain is detected, the USB microprocessor will attempt the 500 mA charging current. If there is a current drain, it will leave the charging network as is. If no current drain is detected, then it indicates a fault and a LED flashes to indicate the fault.

### BACKGROUND-FIELD OF INVENTION

The present invention relates generally to electrical chargers for electronic devices. More specifically, the present invention relates to electrical chargers with microprocessor for electronic devices with universal serial buses.

### BACKGROUND-DESCRIPTION OF RELATED ART

Most modern electronic devices use one or more internal batteries to provide the necessary power to operate the electronic devices. The batteries provide direct current to the electronic device. The internal battery may be either disposable or rechargeable. Disposable batteries require periodic replacement. Rechargeable batteries require periodic recharging from an external power source such as another battery, alternating current source, etc.

Most of the electronic devices recharge its internal rechargeable batteries through its universal serial bus (USB) port. USB ports are based on an industry wide standard and are commonly available. It is found virtually in all modern computers and electronic devices. The USB ports may be used to transfer data as well as to recharge the internal rechargeable batteries.

Electronic devices such as the iPad, iPhone, and iPod lines of products from Apple Inc. located in Cupertino, Calif., require specific power output from the power source to recharge their internal batteries through their USB ports. Many other electronic devices such as the BlackBerry 9700 also require similar but different specific power output from the power source to recharge their internal batteries.

Existing and prior chargers that charge through the USB ports of the electronic devices output a specific power through their USB ports that is specific to a particular electronic device. The charger cannot detect the recharging requirement of the electronic device, and therefore, cannot be used for another electronic device with different recharging requirements. A separate charger that is specific to the electronic device is required for each electronic devices that has a different recharging requirements, even though they all use the same USB port for recharging. Therefore, there exists a need for a single charger that can recharge various electronic devices through their USB ports with varying recharging requirements.

### BRIEF SUMMARY OF THE INVENTION

The USB charger of the present invention is an electrical charger with microprocessor for electronic devices with universal serial buses. The USB charger comprises an alternating current (AC) or direct current (DC) power input, a microprocessor, a resistor network, and a USB port for charging electronic devices through the USB port.

An object of the USB charger is to provide a charger capable of charging various electronic devices through their USB ports. A further object of the USB charger is to provide a charger capable of detecting the required charging current and provide the appropriate charging current. Another object of the USB charger is to provide a charger with light emitting diode indicators to show the different charging modes. Yet another object of the USB charger is to provide a charger that is capable of manual as well as automatic selection of the charging current.

The USB charger defaults to provide 2000 mA when power is applied through the power input. The USB port is monitored to detect when device is connected to it. When a device is detected, it measures device current drain to see if it is charging. If the device is charging, then it remains in the 2000 mA charging mode. If no current drain is detected, the power supply switches to 1000 mA. The microprocessor will turn off power output and then turns it back on. If the electronic device recognizes the proper charging network it will begin charging. When the microprocessor detects current drain, it leaves the charging network as is. If still no current drain is detected, the USB microprocessor will attempt the 500 mA charging current. If there is a current drain, it will leave the charging network as is. If no current drain is detected, then it indicates a fault and a LED flashes to indicate the fault. LED indicators will show the charging mode (i.e., 500, 1000, or 2000 mA) and the fault status. Optionally, a switch will allow the user to bypass auto mode and manually select the proper mode.

### BRIEF DESCRIPTION OF THE DRAWINGS

FIG. 1 shows a block diagram of the USB charger.

FIG. 2 shows the preferred embodiment of the charging process of the USB charger.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

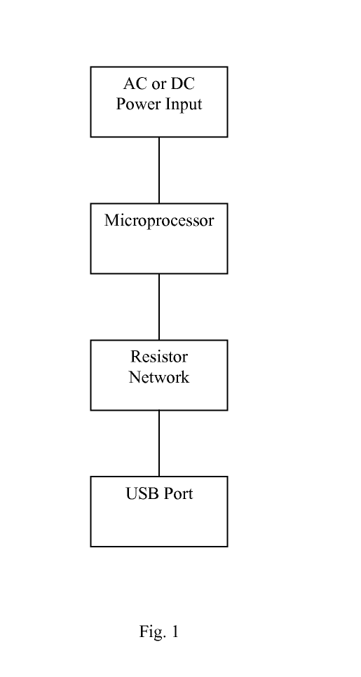

As shown in FIG. 1, the USB charger comprises an alternating current (AC) or direct current (DC) power input, a microprocessor, a resistor network, and a USB port for charging electronic devices through the USB port. In the preferred embodiment, the resistor network defines 3 levels of charging: 500 mA, 1000 mA, and 2000 mA.

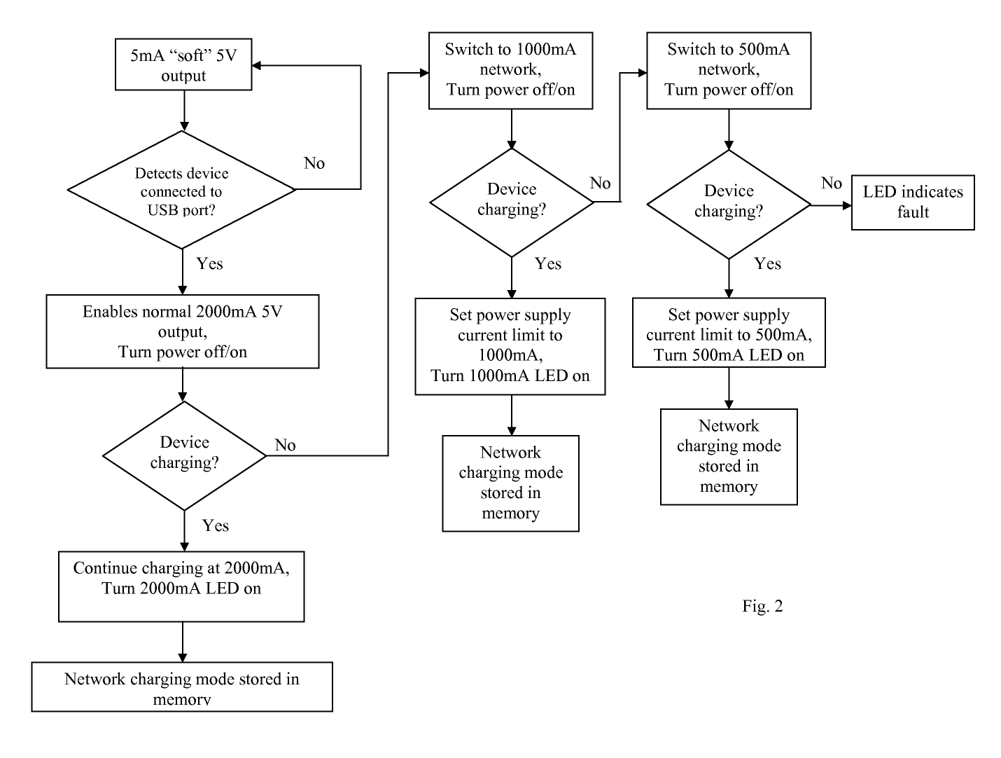

In the preferred embodiment, as shown in FIG. 2, the USB charger defaults to a 2000 mA network upon application of power. The microprocessor monitors the USB port and automatically detects when an electronic device is connected by providing a 5 mA “soft” 5V output. Once an electronic device such as an Apple iPad or iPod is connected, the microprocessor enables the normal 2000 mA 5V output. The microprocessor measures the electronic device's current drain to see if it is charging. If the electronic device is charging, then the USB charger remains in this 2000 mA mode and turns on a light emitting diode (LED) to indicate the 2000 mA charging mode. The resistor network charging mode is stored in memory.

If no current drain is detected (e.g. a BlackBerry 9700 was connected to the USB port) the microprocessor switches to the 1000 mA network. The microprocessor then turns off the power output and then turns it back on. If the electronic device (e.g. the BlackBerry 9700) recognizes proper resistor network and begins charging, the microprocessor will detect charge current and leaves the network as is. An LED is turned on to indicate the 1000 mA charging mode. The resistor network charging mode is stored in memory.

If still no current drain is detected, the microprocessor will switch to the 500 mA resistor network setting. The microprocessor then turns off the power output and then turns it back on. The microprocessor will then check current drain. If it detects current drain, it will leave the resistor network setting as is and turn an LED on to indicate the 500 mA charging mode. The resistor network charging mode is stored in memory.

If still no current drain is detected then the microprocessor indicates a fault and a red LED flashes on the USB charger. The fault may be caused by the use of an improper mini USB cable, for example, that does not contain the normal 200 kΩ resistor at the mini USB plug itself (e.g. the user connected a data sync cable and not a charging cable). Since what may be plugged into the USB port of the USB charger cannot be limited, the USB charger can only indicate fault.

In the preferred embodiment, LED indicators are used to show the charging modes (500, 1000, or 2000 mA). One LED indicator with on/off/flashing may be used to indicate the charging mode. Alternatively, two LED indicators may be used to show charging mode (e.g. one LED indicator for each of the 2000 mA and 1000 mA charging mode and either both on or both off for the 500 mA charging mode.) A fault may be indicated when both LED indicators are flashing. Preferably three LED indicators are used to indicate each of the three charging mode. A fault may be indicated when all three LED indicators are flashing.

In the preferred embodiment, a switch, such as a push button switch, is provided to enable the user to bypass the auto mode and manually select the proper mode. Alternatively, the switch may be a sliding switch or any other suitable switches.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A USB charger with an alternating current or direct current power input, a microprocessor, a resistor network, and a universal serial bus port for recharging an electronic device comprising the process of:
defaulting to a first predetermined current resistor network when power is applied;
providing a low current output to the universal serial bus port;
monitoring the universal serial bus port to detect when an electronic device is connected to the universal serial bus port;
detecting connection of the electronic device to the universal serial bus port;
enabling said first predetermined current output to said universal serial bus port;
measuring current drain to determine if the electronic device is charging;
continuing charging at said first predetermined current if the electronic device is charging;
storing said first predetermined current resistor network setting in memory;
switching to a second predetermined current resistor network if the electronic device is not charging;
turning off power output then turning power output back on;
measuring current drain to determine if the electronic device is charging;
continue charging at said second predetermined current if the electronic device is charging;
storing said second predetermined current resistor network setting in memory; and
turning on a light source to indicate fault if no current drain is detected.

2. A USB charger as in claim 1 wherein said first predetermined current is 2000 mA.

3. A USB charger as in claim 1 wherein said low current output is 5 mA.

4. A USB charger as in claim 1 wherein said second predetermined current is 1000 mA.

5. A USB charger as in claim 1 wherein said light source is a light emitting diode.

6. A USB charger as in claim 1, wherein one or more light emitting diode indicators are used to show the charging current and fault.

7. A USB charger as in claim 1, wherein a switch is provided to enable manual selection of the charging current.

8. A USB charger with an alternating current or direct current power input, a microprocessor, a resistor network, and a universal serial bus port for recharging an electronic device as in claim 1 further comprising the process of:
switching to a third predetermined current resistor network if the electronic device is not charging;
turning off power output then turning power output back on;
measuring current drain to determine if the electronic device is charging;
continue charging at said third predetermined current if the electronic device is charging;
storing said third predetermined current resistor network setting in memory; and
turning on a light source to indicate fault if no current drain is detected.

9. A USB charger as in claim 8 wherein said first predetermined current is 2000 mA.

10. A USB charger as in claim 8 wherein said low current output is 5 mA.

11. A USB charger as in claim 8 wherein said second predetermined current is 1000 mA.

12. A USB charger as in claim 8 wherein said third predetermined current is 500 mA.

13. A USB charger as in claim 8 wherein said light source is a light emitting diode.

14. A USB charger as in claim 8, wherein one or more light emitting diode indicators are used to show the charging current and fault.

15. A USB charger as in claim 8, wherein a switch is provided to enable manual selection of the charging current.

16. A USB charger with an alternating current or direct current power input, a microprocessor, a resistor network, and a universal serial bus port for recharging an electronic device comprising the process of:
defaulting to a first predetermined current resistor network when power is applied;
providing a low current output to the universal serial bus port;
monitoring the universal serial bus port to detect when an electronic device is connected to the universal serial bus port;
detecting connection of the electronic device to the universal serial bus port;
enabling said first predetermined current output to said universal serial bus port;
measuring current drain to determine if the electronic device is charging;
continuing charging at said first predetermined current if the electronic device is charging;
storing said first predetermined current resistor network setting in memory;
switching to a second predetermined current resistor network if the electronic device is not charging;
turning off power output then turning power output back on;
measuring current drain to determine if the electronic device is charging;
continue charging at said second predetermined current if the electronic device is charging;
storing said second predetermined current resistor network setting in memory;
switching to a third predetermined current resistor network if the electronic device is not charging;
turning off power output then turning power output back on;
measuring current drain to determine if the electronic device is charging;
continue charging at said third predetermined current if the electronic device is charging;
storing said third predetermined current resistor network setting in memory; and
turning on a light source to indicate fault if no current drain is detected.

17. A USB charger as in claim 16 wherein said first predetermined current is 2000 mA, said low current output is 5 mA, said second predetermined current is 1000 mA, and said third predetermined current is 500 mA.

18. A USB charger as in claim 16 wherein said light source is a light emitting diode.

19. A USB charger as in claim 16, wherein one or more light emitting diode indicators are used to show the charging current and fault.

20. A USB charger as in claim 16, wherein a switch is provided to enable manual selection of the charging current.
